(19) United States
(12) Patent Application Publication
(10) Pub. No.: US 2025/0119824 A1
(43) Pub. Date: Apr. 10, 2025

(54) METHOD AND DEVICE FOR CONTROLLING ENERGY USE IN WIRELESS COMMUNICATION SYSTEM

(71) Applicant: Samsung Electronics Co., Ltd., Gyeonggi-do (KR)

(72) Inventors: Hoyeon LEE, Gyeonggi-do (KR); Jungshin PARK, Gyeonggi-do (KR); Dongeun SUH, Gyeonggi-do (KR)

(21) Appl. No.: 18/908,155

(22) Filed: Oct. 7, 2024

(30) Foreign Application Priority Data
Oct. 6, 2023 (KR) 10-2023-0133394

(51) Int. Cl. H04W 48/18; H04W 24/08; H04W 76/10

(52) U.S. Cl. CPC H04W 48/18; H04W 24/08; H04W 76/10

(57) ABSTRACT

The disclosure relates to a 5G or 6G communication system for supporting a higher data transmission rate. According to the disclosure, energy use per network slice can be efficiently controlled in a wireless communication system. A method performed by an SMF entity in a wireless communication system includes receiving, from an AMF entity, a first request message for a PDU session establishment including an S-NSSAI; determining whether the S-NSSAI is subject to energy control; and transmitting, to an NF entity, a second request message for an admission control including the S-NSSAI, in case that the S-NSSAI is subject to the energy control.

### CROSS-REFERENCE TO RELATED APPLICATION(S)

This application is based on and claims priority under 35 U.S.C. § 119 to Korean Patent Application No. 10-2023-0133394, which was filed in the Korean Intellectual Property Office on Oct. 6, 2023, the entire disclosure of which is incorporated herein by reference.

### BACKGROUND

### 1. Field

The disclosure relates generally to a device and method for controlling energy use per network slice in a wireless communication system.

### 2. Description of Related Art

5G mobile communication technologies define broad frequency bands such that high transmission rates and new services are possible, and can be implemented not only in “Sub 6 GHZ” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as an LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Accordingly, a need exists for a device and method for efficient energy use and energy saving in a wireless communication system.

### SUMMARY

The disclosure has been made to address at least the above-mentioned problems and/or disadvantages and to provide at least the advantages described below.

Accordingly, an aspect of the disclosure is to provide a method of controlling energy use per network slice in a wireless communication system.

In accordance with an aspect of the disclosure, a method is provided for a session management function (SMF) entity in a wireless communication system. The method includes receiving, from an access and mobility management function (AMF) entity, a first request message for a protocol data unit (PDU) session establishment including a single network slice selection assistance information (S-NSSAI); determining whether the S-NSSAI is subject to energy control; and transmitting, to a network function (NF) entity, a second request message for an admission control including the S-NSSAI, in case that the S-NSSAI is subject to the energy control.

In accordance with another aspect of the disclosure, a method is provided for an NF entity in a wireless communication system. The method includes receiving, from an SMF entity, a first request message for an admission control including an S-NSSAI, in case that a second request message for a PDU session establishment including the S-NSSAI is received by the SMF entity; determining whether the S-NSSAI is subject to energy control based on stored configuration information; and transmitting, to the SMF entity, a first response message for the admission control including information about an energy credit allocated by the NF entity, in case that the S-NSSAI is subject to the energy control.

In accordance with another aspect of the disclosure, an SMF entity is provided for use in a wireless communication system. The SMF entity includes a transceiver; and at least one processor configured to receive, from an AMF entity, via the transceiver, a first request message for a PDU session establishment including an S-NSSAI, determine whether the S-NSSAI is subject to energy control, and transmit, to an NF entity, via the transceiver, a second request message for an admission control including the S-NSSAI, in case that the S-NSSAI is subject to the energy control.

In accordance with another aspect of the disclosure, an NF entity is provided for use in a wireless communication system. The NF entity includes a transceiver; and at least one processor configured to receive, from an SMF entity, via the transceiver, a first request message for an admission control including an S-NSSAI, in case that a second request message for a PDU session establishment including the S-NSSAI is received by the SMF entity, determine whether the S-NSSAI is subject to energy control based on stored configuration information, and transmit, to the SMF entity, via the transceiver, a first response message for the admission control including information about an energy credit allocated by the NF entity, in case that the S-NSSAI is subject to the energy control.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a mobile communication system according to an embodiment;

FIG. 2 is a signal flow diagram illustrating a PDU session establishment procedure according to an embodiment;

FIG. 3 is a signal flow diagram illustrating a method of managing energy resources per S-NSSAI according to an embodiment;

FIG. 4 is a signal flow diagram illustrating a PDU session modification procedure considering an energy credit according to an embodiment;

FIG. 5 is a signal flow diagram illustrating a procedure for selecting an NF considering energy resources according to an embodiment;

FIG. 6 is a signal flow diagram illustrating a procedure for selecting an NF considering energy resources according to an embodiment;

FIG. 7 is a signal flow diagram illustrating a procedure for processing a PDU session request considering energy resources according to an embodiment;

FIG. 8 is a signal flow diagram illustrating a terminal registration procedure considering energy resources according to an embodiment;

FIG. 9 illustrates a terminal according to an embodiment; and

FIG. 10 illustrates an NF entity according to an embodiment.

### DETAILED DESCRIPTION

Hereinafter, embodiments of the disclosure will be described in detail with reference to the accompanying drawings. Detailed descriptions of known functions or configurations that may make the subject matter of the disclosure unclear will be omitted for the sake of clarity and conciseness.

In the drawings, the same or similar elements may be denoted by the same or similar reference numerals. Additionally, some components are exaggerated, omitted, or schematically illustrated in the accompanying drawings. Further, the size of each component may not fully reflect the actual size.

Various advantages and features of embodiments of the disclosure, and methods of achieving them will become apparent with reference to the embodiments described below in detail in conjunction with the accompanying drawings. However, the disclosure is not limited to the embodiments disclosed below, but may be implemented in various different forms, and only embodiments of the disclosure enable the disclosure to be complete, and are provided to fully inform the scope of the disclosure to those of ordinary skill in the art to which the disclosure belongs, and the disclosure is only defined by the scope of the claims.

Each block of signal flow diagrams and combinations of the signal flow diagrams may be performed by computer program instructions. Because these computer program instructions may be mounted in a processor of a general purpose computer, special purpose computer, or other programmable data processing equipment, the instructions performed by a processor of a computer or other programmable data processing equipment generate a device that performs functions described in the signal flow diagram block(s). Because these computer program instructions may be stored in a computer usable or computer readable memory that may direct a computer or other programmable data processing equipment in order to implement a function in a particular manner, the instructions stored in the computer usable or computer readable memory may produce a production article containing instruction means for performing the function described in the signal flow diagram block(s). Because the computer program instructions may be mounted on a computer or other programmable data processing equipment, a series of operation steps are performed on the computer or other programmable data processing equipment to generate a computer-executable process; thus, instructions for performing the computer or other programmable data processing equipment may provide steps for performing functions described in the signal flow diagram block(s).

Further, each block may represent a portion of a module, a segment, or a code including one or more executable instructions for executing a specified logical function(s). Further, it should be noted that in some alternative implementations, functions recited in the blocks may occur out of order. For example, two blocks illustrated one after another may in fact be performed substantially simultaneously, or the blocks may be sometimes performed in the reverse order according to the corresponding function.

The term ‘-unit’ used in this embodiment means software or hardware components such as a field programmable gate array (FPGA) or an application specific integrated circuit (ASIC), and ‘-unit’ performs certain roles. However, ‘-unit’ is not limited to software or hardware. A ‘-unit’ may be formed to reside in an addressable storage medium or may be formed to reproduce one or more processors. Therefore, as an example, ‘-unit’ includes components such as software components, object-oriented software components, class components, and task components, processes, functions, properties, procedures, subroutines, segments of program code, drivers, firmware, microcode, circuit, data, databases (DBs), data structures, tables, arrays, and variables. Functions provided in the components and ‘-units’ may be combined into a smaller number of components and ‘-units’ or may be further separated into additional components and ‘-units’. Further, components and ‘-units’ may be implemented to reproduce one or more CPUs in a device or secure multimedia card. Further, the ‘-unit’ may include one or more processors.

Hereinafter, a term identifying an access node used in the description, a term indicating network entities, a term indicating messages, a term indicating an interface between network objects, a term indicating various identification information and the like are exemplified for convenience of description. Accordingly, the disclosure is not limited to the terms described below, and other terms indicating an object having an equivalent technical meaning may be used.

Hereinafter, for convenience of description, the disclosure uses terms and names defined in the 3rd generation partnership project long term evolution (3GPP LTE) standard and 3GPP 5G standard. However, the disclosure is not limited by the above terms and names, and may be equally applied to systems conforming to other standards.

Hereinafter, the disclosure relates to a device and method for efficient energy use and energy saving in a wireless communication system. Specifically, the disclosure describes technology for controlling and managing efficient energy use or energy saving in a mobile communication network system that supports efficient energy use per network slice.

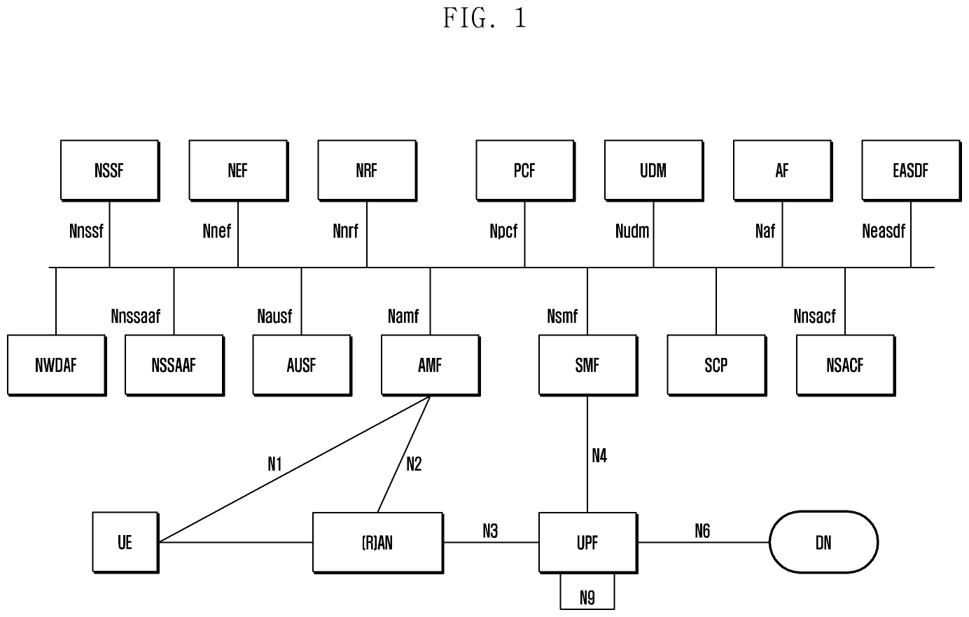

FIG. 1 illustrates a mobile communication system according to an embodiment.

Referring to FIG. 1, a 5G system (5GS), which is a mobile communication system may include a terminal (or UE), a base station (or (R)AN), and a 5G core network. The 5G core network may include the remaining NFs excluding the UE, a (R)AN, a data network (DN), and an application function (AF) of FIG. 1. Specifically, the 5G core network may include an AMF, an SMF, a user plane function (UPF), a policy control function (PCF), a unified data management (UDM), a unified data repository (UDR), a network repository function (NRF), a network data analytics function (NWDAF), and a network exposure function (NEF). The UE may access a 5G core network through a base station ((R)AN). Hereinafter, the UE may be referred to as a terminal, and the (R)AN may be referred to as a base station. Additionally, the 5G core network may further include the AF and the DN.

The AMF is an NF that manages wireless network access and mobility for the UE.

The SMF is an NF that manages sessions for the UE, and session information may include quality of service (QOS) information, charging information, and packet processing information.

The UPF is an NF that processes user traffic (i.e., user plane traffic) and is controlled by the SMF.

The PCF is an NF that manages an operator policy (e.g., public land mobile network (PLMN) policy) for providing a service in a wireless communication system. Additionally, the PCF may be divided into a PCF responsible for an access and mobility (AM) policy and a UE policy and a PCF responsible for a session management (SM) policy. The PCF responsible for an AM/UE policy and the PCF responsible for an SM policy may be logically or physically separated NFs or may be logically or physically one NF.

The UDM is an NF that stores and manages subscriber information (e.g., a UE subscription) of the UE.

The NSACF is an NF that manages admission control of a network slice.

The UDR is a NF or DB that stores and manages data. The UDR may store UE subscription information and provide UE subscription information to the UDM. Further, the UDR may store operator policy information and provide operator policy information to the PCF.

The NRF performs a function of registering and managing an NF function of the 5G core network, and searching for and selecting NFs that satisfy required functions.

The NWDAF performs a function of analyzing data and providing analysis information to the NF, base station, UE, and AF of the 5G core network.

The NEF may be used for exposing 5G network core functions to the outside and performing communication between the AF and the 5G core network.

The AF may be an NF that provides a function for a service according to the disclosure.

The DN may provide an operator service, Internet access, or third party service.

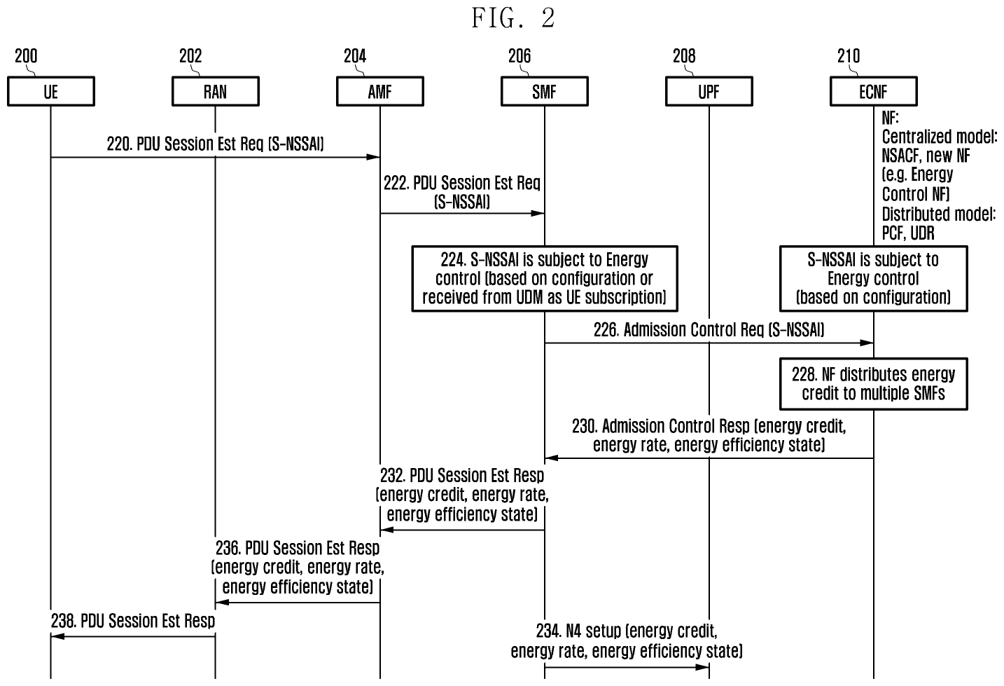

FIG. 2 illustrates a PDU session establishment procedure according to an embodiment.

Referring to FIG. 2, an energy control NF (ECNF) 210 may be an NF responsible for energy control per network slice (S-NSSAI). In a centralized model, there may be one ECNF 210 responsible for energy control related to the S-NSSAI in the center, and the ECNF 210 may be one (e.g., NSACF) of 5G NFs illustrated in FIG. 1 or a new NF. In a distributed model, multiple ECNFs 210 may be responsible for energy control related to the S-NSSAI in a distributed manner, and the NF may be one (e.g., PCF, UDR) of 5G NFs illustrated in FIG. 1 or a new NF. The ECNF 210 may be configured with information on whether an S-NSSAI is an energy control target or information on an S-NSSAI to be an energy control target. The energy resource may be at least one of an energy credit, energy rate, energy efficiency state, or energy mode.

At step 220, a UE 200 transmits a PDU session establishment request message to an AMF 204. The PDU session establishment request message may include information on a network slice (S-NSSAI) wanting to establish a PDU session.

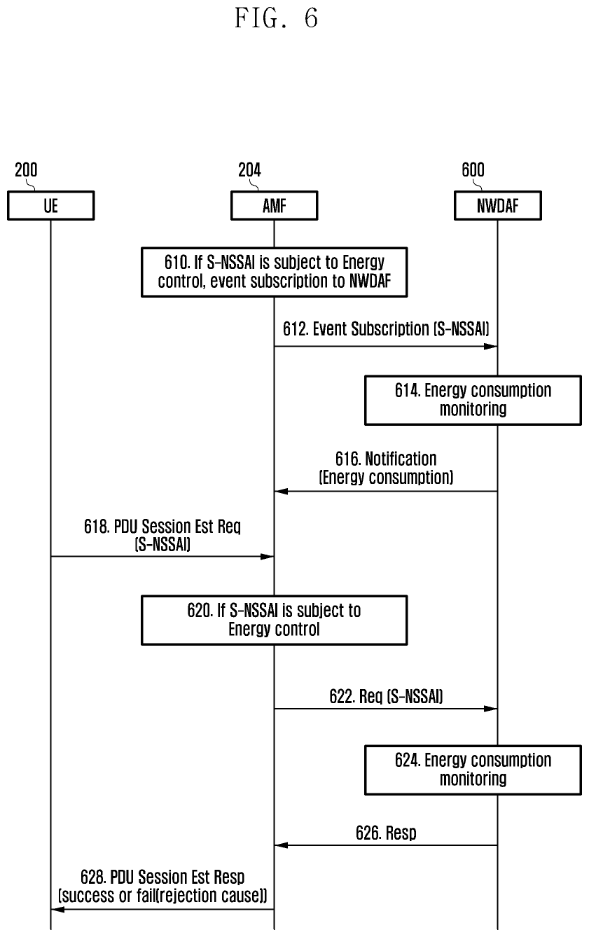

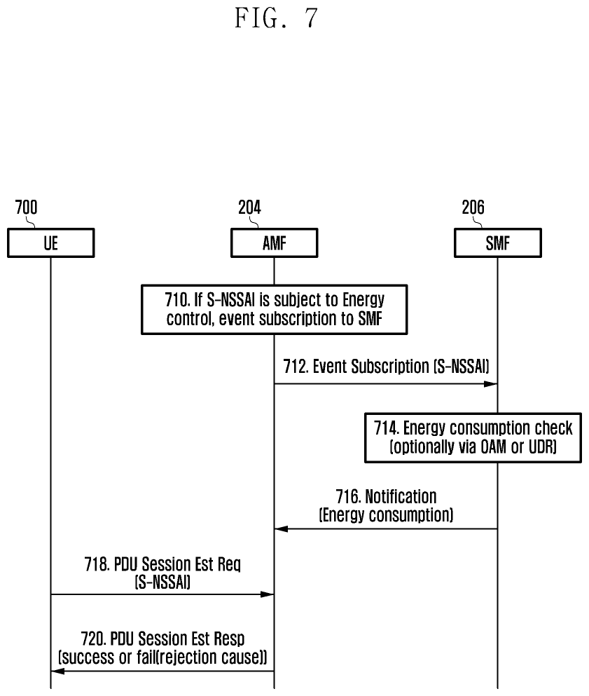

At step 222, the AMF 204 selects an SMF 206 that supports the S-NSSAI and transmits a PDU session establishment request message to the SMF 206. Examples of SMF selection methods will be described below with reference to FIGS. 6 and 7.

At step 224, the SMF 206 determines whether the S-NSSAI included in the PDU session establishment request message is a network slice for an energy control target. The SMF 206 may determine whether the S-NSSAI is an energy control target based on UE subscription information received from a UDM or configuration information stored in the SMF (e.g., S-NSSAI information to be an energy configuration target).

When the S-NSSAI is an energy configuration target, the SMF 206 transmits a request message (e.g., approval control request message) to the ECNF 210 at step 226. The request message may include an S-NSSAI.

At step 228, the ECNF 210 determines whether the requested S-NSSAI is an energy control target. For example, the ECNF 210 may determine the S-NSSAI to be an energy control target based on the configuration information stored therein. The ECNF 210 may perform energy resource distribution for an S-NSSAI, which is the requested energy control target. The energy resource may include at least one of a total energy amount available by the S-NSSAI, energy rate, or energy efficiency mode. The ECNF 210 may allocate some of energy resources available by the S-NSSAI to a PDU session requested by the UE 200.

At step 230, the ECNF 210 returns a response message (e.g., approval control response message) to the SMF 206. The response message may include energy resource information allocated by the NF. The energy resource information may include at least one of an energy rate or an energy use mode available by the S-NSSAI.

At step 232, the SMF 206 transmits a PDU session response message to the AMF 204. The response message may include energy resource information allocated to the PDU session. The energy resource information may include at least one of an energy rate or an energy use mode available by the S-NSSAI.

At step 234, the SMF 206 transmits an N4 setup request message to an UPF 208. The N4 setup message may include energy resource information allocated to the PDU session. The energy resource information may include at least one of an energy rate or an energy use mode available by the S-NSSAI.

At steps 236 to 238, the AMF 204 transmits a PDU session response message to the UE 200 through a base station (RAN) 202. The RAN 202 may store received energy resource information.

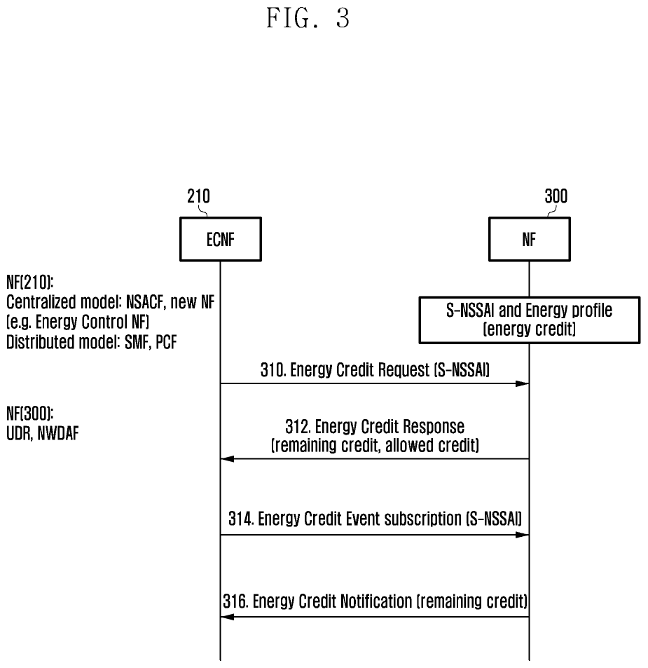

FIG. 3 is a signal flow diagram illustrating a method of managing energy resources per S-NSSAI according to an embodiment.

Referring to FIG. 3, an NF 300 may be an NF that manages a total amount (energy credit) of energy resources per S-NSSAI. Alternatively, the NF 300 may be an NF that manages energy credit statistics per S-NSSAI and that monitors a real-time energy credit. The NF 300 may manage an energy profile linked to the S-NSSAI. The NF 300 may be one (e.g., UDR, NWDAF) of the 5G NFs illustrated in FIG. 1 or a new NF. The ECNF 210 may communicate with NF 300 and perform an operation for energy control per S-NSSAI.

The ECNF 210 and the NF 300 may communicate using at least one of two communication methods.

For example, the ECNF 210 and the NF 300 may communicate in a request-response manner. In this case, at step 310, the ECNF 210 transmits an energy credit request message to the NF 300. Step 310 may occur at step 228 for the ECNF to perform an operation for allocating an energy credit to a PDU session at step 228 of FIG. 2. The energy credit request message may include an S-NSSAI. The NF 300 may identify energy resources available by the S-NSSAI. Alternatively, the NF 300 may monitor an amount of energy in which the S-NSSAI has used up to now.

At step 312, the NF 300 transmits a response message to the ECNF. The response message may include at least one of an amount of energy in which the S-NSSAI has used up to now or an amount of remaining energy.

Alternatively, for example, the ECNF 210 and the NF 300 may communicate in a subscription-notification manner. In this case, at step 314, the ECNF 210 transmits an energy credit subscription message to the NF 300. The subscription message may include an S-NSSAI. The NF 300 may identify energy resources available by the S-NSSAI. Alternatively, the NF 300 may monitor an amount of energy being used by the S-NSSAI. In the case that an amount of energy being used by the S-NSSAI exceeds a certain limit or in the case that an amount of energy available by the S-NSSAI is less than a certain limit, the NF 210 transmits a notification message to the ECNF 300 at step 316. The notification message may include at least one of an amount of energy used by the S-NSSAI up to now or an amount of remaining energy.

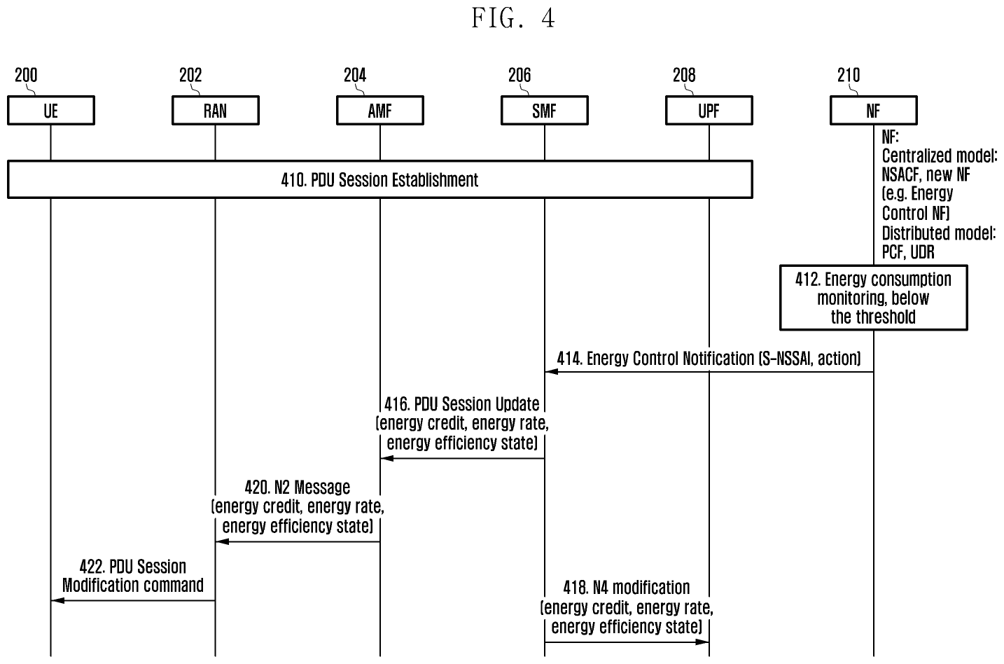

FIG. 4 illustrates a PDU session modification procedure considering an energy credit according to an embodiment.

Referring to FIG. 4, at step 410, the UE 200 establishes a PDU session using an S-NSSAI. The PDU session establishment procedure may follow the procedure illustrated in FIG. 2.

At step 412, the NF 210 monitors an energy credit. The NF 210 may determine that an energy credit has exceeded a certain threshold. Alternatively, the NF 210 may determine that a remaining energy credit is less than a certain threshold. Based on the determination result, the NF 210 may determine to lower an energy rate of a currently used PDU session.

At step 414, the NF 210 transmits a notification message to the SMF 206 controlling the PDU session. The notification message may include a request to reduce energy use. Alternatively, the notification message may include information on energy resources newly allocated to the PDU session (e.g., an energy rate lower than the energy rate configured in the PDU session establishment procedure at step 410, an energy use mode lower than an energy mode configured in the PDU session establishment procedure at step 410).

The SMF 206 determines to modify the PDU session based on the information received at step 414.

At step 416, the SMF 206 transmits a PDU session update message to the AMF 204. The PDU session update message may include modified energy resource information. The modified energy resource information may include at least one of an energy rate or energy use mode available by the S-NSSAI.

At step 418, the SMF 206 transmits an N4 modification request message to the UPF 208. The N4 modification message may include modified energy resource information allocated to the PDU session. The modified energy resource information may include at least one of an energy rate or an energy use mode available by the S-NSSAI.

At steps 420 to 422, the AMF 204 transmits a PDU session modification message to the UE 200 through the RAN 202. The PDU session modification message may include modified energy resource information allocated to the PDU session. The RAN 202 may store the received energy resource information.

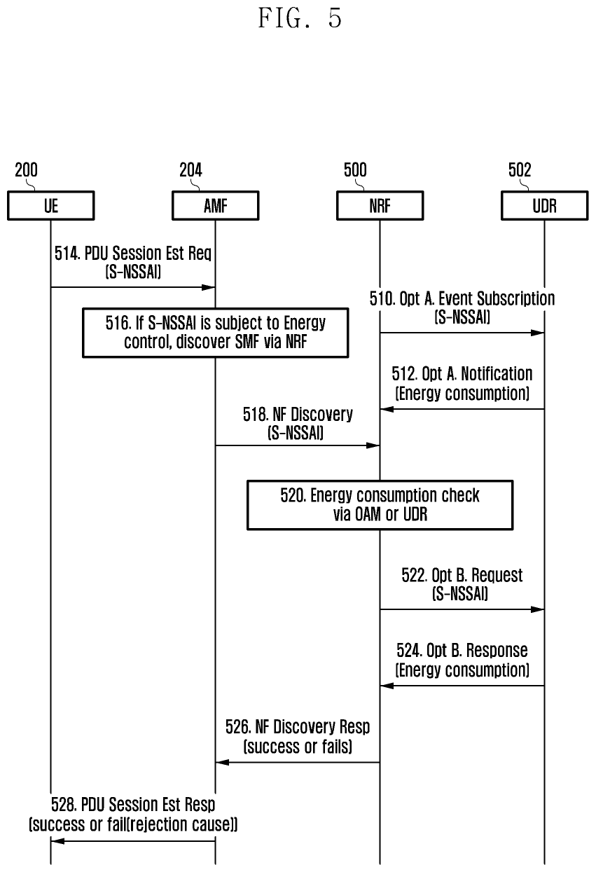

FIG. 5 is a signal flow diagram illustrating a procedure for selecting an NF considering energy resources according to an embodiment.

Referring to FIG. 5, an NRF 500 may be an NF that stores and manages NF information of the 5G network illustrated in FIG. 1. The NRF 500 may acquire current energy resource information from a UDR 502 that stores energy resource information per S-NSSAI.

For example, the NRF 500 transmits an event subscription request message for energy resources to the UDR 502 at step 510. The event subscription request message may include an S-NSSAI to be a target of energy resources. In the case that energy resources available by the S-NSSAI fall a certain amount or less/less than a certain amount, the event subscription request message may be an event subscription request requesting to transmit a notification message to the NRF 500. The UDR 502 may manage stored energy resource information available by the S-NSSAI.

When energy resources available by the S-NSSAI fall a certain amount or less/less than a certain amount, the UDR 502 transmits a notification message of step 512 to the NRF 500. The notification message may include information on energy resources available by the S-NSSAI (e.g., information on remaining energy resources, information indicating that all energy has been consumed and is unavailable). In the case that the NRF 500 receives a message at step 512, the NRF 500 may determine that the corresponding S-NSSAI is no longer capable of providing a service.

At step 514, the UE 200 transmits a PDU session establishment request message to the AMF 204. The PDU session establishment request message may include an S-NSSAI. The AMF 204 may determine whether the S-NSSAI is an energy control target based on configuration information stored therein or subscription information received from an UDM (not illustrated). In the case that the S-NSSAI is an energy control target, the AMF 204 may determine to select the SMF through the NRF 500 so as to process the PDU session establishment request message.

At step 518, the AMF 204 transmits an NF discovery request message to the NRF 500. The NF discovery request message may include an SMF, which is an NF type that the AMF 204 wants to discover, and S-NSSAI information.

At step 520, the NRF 500 performs an operation for discovering the requested NF. For example, the NRF 500 may determine whether the S-NSSAI is available (e.g., whether the S-NSSAI is unavailable because all energy thereof is consumed) based on a configuration by the OAM or a notification message received from the UDR 502 at step 512.

Alternatively, in order to determine whether the S-NSSAI is available considering an energy credit, the NRF 500 may transmit a request message to the UDR 502 at step 522. The request message may include an S-NSSAI. The request message may be a request message for finding out the remaining energy amount of the S-NSSAI. The UDR 502 may manage stored available energy resource information of the S-NSSAI.

The UDR 502 may include energy resource information available by the S-NSSAI in a response message at step 524 and transmit the response message. The response message may include information on energy resources available by the S-NSSAI (e.g., remaining energy resource information and information indicating that all energy has been consumed and is unavailable).

The NRF 500 may determine whether the S-NSSAI is available based on a configuration by the OAM or information received from the UDR 502 at step 512 or step 524. In the case that the S-NSSAI has available energy, the NRF 500 may select an SMF supporting the S-NSSAI.

At step 526, the NRF 500 transmits the selected SMF to the AMF 204. In the case that the S-NSSAI has consumed all available energy and is unavailable, the NRF 500 may not select any SMF. At step 526, the NRF 500 may transmit a message indicating an NF discovery failure to the AMF 204.

The AMF 204 that has received SMF information at step 526 may transmit a PDU session establishment request message to the corresponding SMF to perform a PDU session establishment procedure. The PDU session establishment procedure may correspond to steps 222 to 238 of FIG. 2.

The AMF 204 that has received the NF discovery failure response at step 526 may transmit a PDU session establishment rejection message to the UE 200 (step 528).

FIG. 6 is a signal flow diagram illustrating a procedure for selecting an NF considering energy resources according to an embodiment of the disclosure.

Referring to FIG. 6, an NWDAF 600 may be an NF that monitors and manages an NF status of the 5G network illustrated in FIG. 1. The NWDAF 600 may monitor energy resource use information per S-NSSAI.

At step 610, S-NSSAI information to be an energy control target may be configured in the AMF 204. The AMF 204 may determine to subscribe to an event to the NWDAF 600 so as to know energy resource use amount information of the S-NSSAI.

At step 612, the AMF 204 transmits an event subscription request message for an energy resource to the NWDAF 600. The event subscription request message may include an S-NSSAI to be a target of the energy resource. The event subscription request message may be an event subscription request requesting to transmit a notification message to the AMF 204 in the case that an energy resource available by the S-NSSAI falls a certain amount or less/less than a certain amount.

At step 614, the NWDAF 600 monitors energy resource information available by the S-NSSAI in a mobile communication network (e.g., 5G NF illustrated in FIG. 1). In the case that an energy resource available by the S-NSSAI exceeds a certain amount, the NWDAF 600 transmits a notification message to the AMF 204 at step 616. The notification message may include energy resource information available by the S-NSSAI (e.g., remaining energy resource information, information indicating that all energy has been consumed and is unavailable). In the case that the AMF 204 receives the message at step 616, the AMF 204 may determine that the corresponding S-NSSAI is no longer capable of providing a service.

At step 618, the UE 200 transmits a PDU session establishment request message to the AMF 204. The PDU session establishment request message may include an S-NSSAI.

At step 620, the AMF 204 determines whether the S-NSSAI is an energy control target based on configuration information stored therein or subscription information received from an UDM.

The AMF 204 may determine whether the S-NSSAI is available (e.g., whether the S-NSSAI is unavailable because all of energy thereof is consumed) based on a configuration by the OAM or the notification message received from the NWDAF 600 at step 616. Alternatively, the AMF 204 may transmit a request message to the NWDAF 600 at step 622 so as to determine whether the S-NSSAI is available considering an energy credit. The request message may include an S-NSSAI. The request message may be a request message for finding out an amount of energy used by the S-NSSAI.

At step 624, the NWDAF 600 monitors energy resources used by the S-NSSAI. The NWDAF 600 may include information on energy resources available by the S-NSSAI in a response message at step 626 and transmit the response message. For example, the response message may include information on energy resources available by the S-NSSAI (e.g., at least one of remaining energy resource information or information indicating that all energy has been consumed and is unavailable). Alternatively, the response message may include information on energy resources used by the S-NSSAI up to now. As yet another alternative, the response message may include a recommended action (e.g., rejecting PDU session establishment because all energy has been consumed, etc.).

The AMF 204 may determine whether the S-NSSAI is available based on the information received from the NWDAF 600 at step 616 or step 626 or the configuration by the OAM. For example, in the case of receiving remaining energy resource information available by the S-NSSAI from the OAM or the NWDAF, the AMF 204 may determine to accept the PDU session in the case that the remaining energy resources are sufficient.

Alternatively, in the case of receiving energy resource information used by the S-NSSAI up to now from the OAM or the NWDAF 600, the AMF 204 may calculate the remaining energy resources and determine to accept the PDU session in the case that the remaining energy resources are sufficient.

Alternatively, in the case that the AMF 204 receives a recommended action (e.g., rejecting PDU session establishment) from the NWDAF 600, the AMF 204 may determine whether to perform the recommended action received from the NWDAF 600.

The AMF 204 that has determined to accept a PDU session may perform a PDU session establishment procedure. The PDU session establishment procedure may correspond to steps 222 to 238 of FIG. 2.

The AMF 204 that has determined to reject a PDU session may transmit a PDU session establishment rejection message to the UE 200 at step 628.

FIG. 7 is a signal flow diagram illustrating a procedure for processing a PDU session request considering energy resources according to an embodiment.

Referring to FIG. 7, at step 710, S-NSSAI information to be an energy control target may be configured in the AMF 204. For an S-NSSAI to be an energy control target, the AMF 204 may determine to subscribe to an event to the SMF 206 supporting the S-NSSAI. For example, the AMF 204 may determine to subscribe to an event to the SMF 206 selected during the PDU session establishment procedure illustrated in FIG. 2. The AMF 204 may transmit an event subscription request message of step 712 after step 222 of FIG. 2.

Alternatively, the AMF 204 may transmit an event subscription request message of step 712 to the message of step 222 of FIG. 2. In this case, the PDU session establishment procedure of FIG. 2 may be a procedure requested by an UE 700, and the event subscription request message of step 712 may be an event subscription request message for the S-NSSAI not related to the UE 700.

Alternatively, the AMF 204 may determine to subscribe to an event to the selected SMF 206 through the procedure illustrated in FIG. 5.

At step 712, the AMF 204 transmits an event subscription request message for an energy resource to the SMF 206. The event subscription request message may include an S-NSSAI to be a target of the energy resource. The event subscription request message may be an event subscription request requesting to transmit a notification message to the AMF in the case that an energy resource available by the S-NSSAI falls a certain amount or less/less than a certain amount.

At step 714, the SMF 206 monitors available energy resource information of the S-NSSAI supported by the SMF 206. In the case that an energy resource available by the S-NSSAI exceeds a certain amount, the SMF 206 transmits a notification message of step 716. The notification message may include information on the energy resource available by the S-NSSAI (e.g., information on the remaining energy resource, information indicating that all energy has been consumed and is unavailable).

In the case that the AMF 204 receives the message of step 716, the AMF 204 may determine that the corresponding S-NSSAI (or the corresponding SMF may no longer support the S-NSSAI) is no longer capable of providing a service.

The AMF 204 may transmit a PDU session establishment request message for the S-NSSAI received by the AMF 204 to the SMF 206 before receiving a notification message of step 716 to perform a PDU session establishment procedure.

After receiving the notification message of step 716, in the case that the AMF 204 receives a PDU session establishment request message for the S-NSSAI, e.g., a PDU session establishment request message of step 718, the AMF 204 may determine that the corresponding S-NSSAI may not be provided based on the message of step 716. Accordingly, the AMF 204 transmits a PDU session rejection message to the UE at step 720.

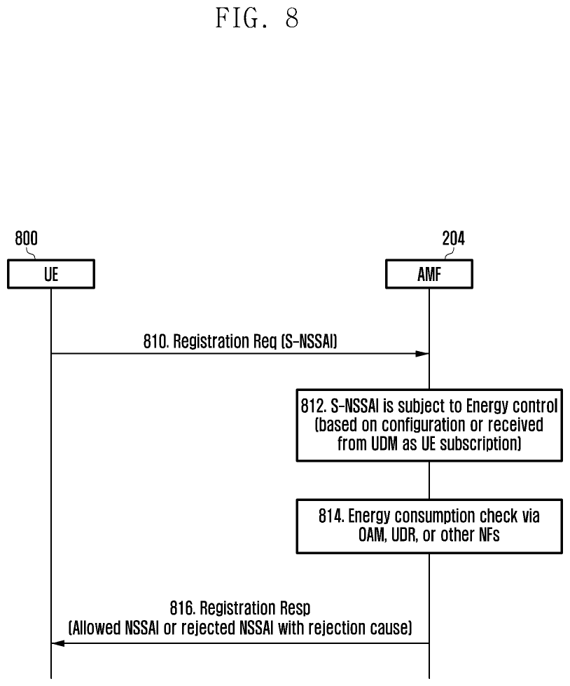

FIG. 8 illustrates a UE registration procedure considering energy resources according to an embodiment.

Referring to FIG. 8, at step 810, a UE 800 transmits a registration request message to the AMF 204. The registration request message may include an S-NSSAI.

At step 812, the AMF 204 determines whether the S-NSSAI is an energy control target based on configuration information stored therein or subscription information received from the UDM. For example, the AMF 204 may determine whether the S-NSSAI included in the registration request message is an energy control target.

At step 814, the AMF 204 determines an energy resource use status of the S-NSSAI and/or availability of the S-NSSAI using at least one of various methods described in the embodiments of the disclosure.

In the case that the S-NSSAI is available, the AMF 204 may transmit a registration response message to the UE 800 at step 816. The registration response message may include information indicating that the S-NSSAI requested by the UE 800 at step 810 is allowed.

In the case that the S-NSSAI is unavailable, the AMF 204 may transmit a registration response message to the UE 800 at step 816. The registration response message may include information indicating that the S-NSSAI requested by the UE 800 at step 810 was rejected. Alternatively, the AMF 204 may transmit a registration rejection message to the UE 800 at step 816.

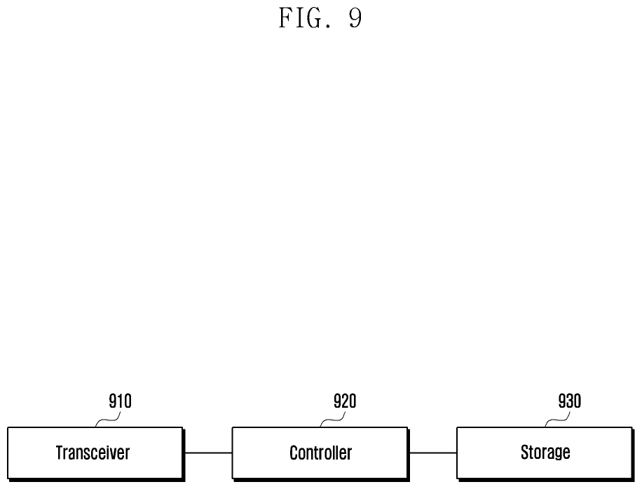

FIG. 9 illustrates a UE according to an embodiment.

Referring to FIG. 9, the UE includes a transceiver 910, a controller 920, and a storage 930. The controller 920 may include a circuit, an ASIC, or at least one processor.

The transceiver 910 may transmit and receive signals to and from other network entities. The transceiver 910 may transmit and receive signals to and from the AMF through, e.g., the base station.

The controller 920 may control the overall operation of the UE according to the above-described embodiments. For example, the controller 920 may control the signal flow between each block so as to perform the operation according to the signal flow diagrams described above.

The storage 930 may store at least one of information transmitted and received through the transceiver 910 or information generated through the controller 920.

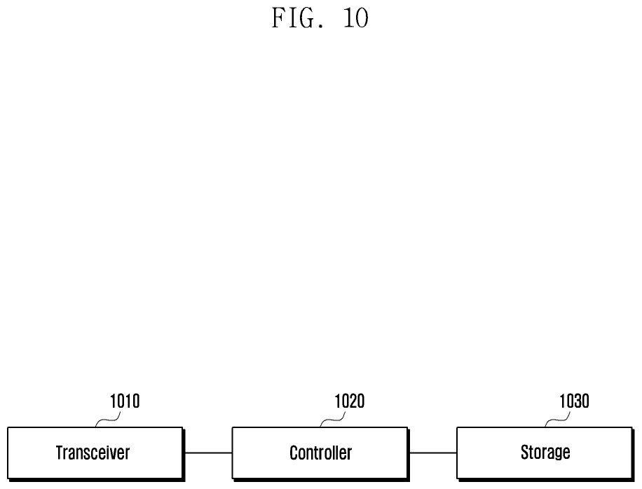

FIG. 10 illustrates an NF entity according to an embodiment. For example, the NF entity of FIG. 10 may be an AMF, an SMF, an NRF, a UDR, an NWDAF, etc.

Referring to FIG. 10, the NF entity includes a transceiver 1010, a controller 1020, and a storage 1030. The controller 1020 may include a circuit, an ASIC, or at least one processor.

The transceiver 1010 may transmit and receive signals to and from other network entities. For example, in the case of the AMF, the transceiver 1010 may transmit an event subscription request message for energy resources to other network entities such as the NWDAF or the SMF.

The controller 1020 may control the overall operation of the NF entity according to the above-described embodiments. For example, the controller 1020 may control the signal flow between each block so as to perform the operation according to the signal flow diagram described above. Specifically, the controller 1020 may determine whether the S-NSSAI is an energy control target based on subscription information according to the embodiment of the disclosure.

The storage 1030 may store at least one of information transmitted and received through the transceiver 1010 or information generated through the controller 1020.

According to the above-described embodiments of the disclosure, energy use per network slice can be efficiently controlled in a wireless communication system.

In the embodiments of the disclosure described above, components are expressed in the singular or plural according to the presented specific embodiments. However, the singular or plural expression is appropriately selected for a situation presented for convenience of description, and the disclosure is not limited to the singular or plural component, and even if a component is represented in the plural, it may be composed of a singular component, or even if a component is represented in the singular, it may be composed of plural components.

Embodiments of the disclosure disclosed in this specification and drawings merely present specific examples in order to easily describe the technical contents of the disclosure and help the understanding of the disclosure, and they are not intended to limit the scope of the disclosure. That is, it will be apparent to those of ordinary skill in the art to which the disclosure pertains that other modifications based on the technical spirit of the disclosure may be implemented. Further, each of the above embodiments may be operated in combination with each other, as needed. For example, the base station and the UE may be operated by combining parts of an embodiment and another embodiment of the disclosure with each other. Further, other modifications based on the technical idea of the embodiment may be implemented in various systems such as a frequency division duplexing (FDD) LTE system, a time division duplexing (TDD) LTE system, a 5G system, or an NR system.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a session management function (SMF) entity in a wireless communication system, the method comprising:
receiving, from an access and mobility management function (AMF) entity, a first request message for a protocol data unit (PDU) session establishment including a single network slice selection assistance information (S-NSSAI);
determining whether the S-NSSAI is subject to energy control; and
transmitting, to a network function (NF) entity, a second request message for an admission control including the S-NSSAI, in case that the S-NSSAI is subject to the energy control.

2. The method of claim 1,
wherein, in case that the S-NSSAI is subject to the energy control based on configuration information stored in the NF entity, an energy credit is distributed for the S-NSSAI by the NF entity.

3. The method of claim 1, further comprising receiving, from the NF entity, a first response message for the admission control including information about an energy credit allocated by the NF entity.

4. The method of claim 1, further comprising transmitting, to the AMF entity, a second response message for the PDU session establishment including information about an energy credit allocated to a PDU session.

5. A method performed by a network function (NF) entity in a wireless communication system, the method comprising:
receiving, from a session management function (SMF) entity, a first request message for an admission control including a single network slice selection assistance information (S-NSSAI), in case that a second request message for a protocol data unit (PDU) session establishment including the S-NSSAI is received by the SMF entity;
determining whether the S-NSSAI is subject to energy control based on stored configuration information; and
transmitting, to the SMF entity, a first response message for the admission control including information about an energy credit allocated by the NF entity, in case that the S-NSSAI is subject to the energy control.

6. The method of claim 5, further comprising:
allocating, to a PDU session requested by a terminal, at least one energy credit available to the S-NSSAI.

7. The method of claim 5, wherein the first response message includes at least one of information on an energy rate available to the S-NSSAI, or information on an energy use mode.

8. The method of claim 7,
wherein a second response message for the PDU session establishment is transmitted, from the SMF entity, to an access and mobility management function (AMF) entity, and
wherein the second response message includes the at least one of the information on the energy rate available to the S-NSSAI, or the information on the energy use mode.

9. A session management function (SMF) entity in a wireless communication system, the SMF entity comprising:
a transceiver; and
at least one processor configured to:
receive, from an access and mobility management function (AMF) entity, via the transceiver, a first request message for a protocol data unit (PDU) session establishment including a single network slice selection assistance information (S-NSSAI),
determine whether the S-NSSAI is subject to energy control, and
transmit, to a network function (NF) entity, via the transceiver, a second request message for an admission control including the S-NSSAI, in case that the S-NSSAI is subject to the energy control.

10. The SMF entity of claim 9,
wherein, in case that the S-NSSAI is subject to the energy control based on configuration information stored in the NF entity, an energy credit is distributed for the S-NSSAI by the NF entity.

11. The SMF entity of claim 9, wherein the at least one processor is further configured to:
receive, from the NF entity, via the transceiver, a first response message for the admission control including information about an energy credit allocated by the NF entity.

12. The SMF entity of claim 9, wherein the at least one processor is further configured to:
transmit, to the AMF entity, via the transceiver, a second response message for the PDU session establishment including information about an energy credit allocated to a PDU session.

13. A network function (NF) entity in a wireless communication system, the NF entity comprising:
a transceiver; and
at least one processor configured to:
receive, from a session management function (SMF) entity, via the transceiver, a first request message for an admission control including a single network slice selection assistance information (S-NSSAI), in case that a second request message for a protocol data unit (PDU) session establishment including the S-NSSAI is received by the SMF entity,
determine whether the S-NSSAI is subject to energy control based on stored configuration information, and
transmit, to the SMF entity, via the transceiver, a first response message for the admission control including information about an energy credit allocated by the NF entity, in case that the S-NSSAI is subject to the energy control.

14. The NF entity of claim 13, wherein the at least one processor is further configured to:
Allocate, to a PDU session requested by a terminal, at least one energy credit available to the S-NSSAI.

15. The NF entity of claim 13,
wherein the first response message includes at least one of information on an energy rate available to the S-NSSAI, or information on an energy use mode.

16. The NF entity of claim 15,
wherein a second response message for the PDU session establishment is transmitted, from the SMF entity, to an access and mobility management function (AMF) entity, and
wherein the second response message includes the at least one of the information on the energy rate available to the S-NSSAI, or the information on the energy use mode.
